(19) United States
(12) Patent Application Publication
(10) Pub. No.: US 2004/0009104 A1
(43) Pub. Date: Jan. 15, 2004

(54) Evaporator arrangement, particularly for production of a hydrocarbon/ mixing material mixture, decomposable for hydrogen recovery in a reformer

(76) Inventors: Andreas Kaupert, Ulm (DE); Gunter Eberspach, Wolfschlugen (DE); Heinrich Kohne, Aachen (DE)

Correspondence Address: M. Robert Kestenbaum, 11011 Bermuda Dunes NE, Albuquerque, NM, 87111, US

(21) Appl. No.: 10/614,302

(22) Filed: Jul. 3, 2003

(30) Foreign Application Priority Data
Jul. 12, 2002 (DE) 102 31 883.2-44

(51) Int. Cl. B01D 50/00

(52) U.S. Cl. 422/168; 48/61

(57) ABSTRACT

An evaporator arrangement for producing a hydrocarbon/mixing material mixture that can be decomposed for hydrogen recovery in a reformer includes a porous evaporator medium, a hydrocarbon supply duct arrangement for supplying hydrocarbon to the porous evaporator medium, and also a mixing material conducting arrangement for conducting through the evaporator medium at least a portion of the mixing material provided for mixture formation.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to an evaporator arrangement, particularly for the production of a hydrocarbon/mixing material mixture that is decomposable for hydrogen recovery in a reformer.

Reformers decompose hydrocarbons or hydrocarbon-containing materials in a catalytic reaction, and thereby release or recover hydrogen. This hydrogen can be used, for example, in fuel cells for producing electrical energy, but can also be used, for example, for exhaust gas treatment in an exhaust gas conducting system of an internal combustion engine. For its efficient performance, the catalytic reaction taking place in such a reformer requires that, on the one hand, comparatively high temperatures (in the region of about 320° C.) are present in the region of the catalyst material at the beginning of the reaction. On the other hand, it is necessary that the mixture of hydrocarbons and, for example, air (if necessary with the addition of water vapor) fed to the catalyst material be as homogeneous as possible.

### SUMMARY OF THE INVENTION

The object of the present invention is to provide an evaporator arrangement, for example for the production of a hydrocarbon/mixing material mixture that can be decomposed in a reformer for hydrogen recovery, with which evaporator arrangement there can be attained good mixing with the hydrocarbon of the mixing material provided for mixture formation.

According to the invention, this object is attained by an evaporator arrangement, particularly for the production of a hydrocarbon/mixing material mixture that can be decomposed in a reformer for hydrogen recovery, including a porous evaporator medium, a hydrocarbon supply duct arrangement for supplying hydrocarbon to the porous evaporator medium, and also a mixing material arrangement for conducting through the evaporator medium at least a portion of the mixing material provided for mixture formation.

By the flow of the mixing material provided for mixture formation, or at least a portion thereof, through the porous material taking up the liquid hydrocarbon, for example diesel fuel, it is ensured that a contact between the mixing material and the hydrocarbon already exists in this porous medium, and here, on the one hand, a transport effect is obtained, so that hydrocarbon present in the porous medium is entrained by the mixing material flowing through this. On the other hand, a certain amount of mixing is already produced in the porous medium.

In order to improve the passage of mixing material through the porous evaporator medium, it is proposed that the evaporator medium has numerous mixing material passage apertures. Such mixing material passage apertures can, in general, provide respectively a cross section or a cross sectional surface that is larger than the average cross sectional surface of the pores present in the porous material, so that the mixing material substantially flows through the porous material in the region of these mixing material passage apertures.

In order to support the evaporation of the fuel in the porous evaporator medium, particularly in the starting phase in which the various system regions are, or can be, still comparatively cold, it is proposed that an electrically operable heating device is associated with the evaporator medium. It is preferably then provided that the heating device is arranged—in relation to the flow of mixing material through the evaporator medium—on an upstream side of the evaporator medium and in heat transfer contact therewith.

In order to ensure that the heat provided by the heating device can be used at least to a substantial degree for heating the porous medium or the liquid hydrocarbon to be evaporated therein, it is proposed that the heating device has associated with it a screening arrangement to screen it off from the mixing material flowing to the evaporator medium. The screening arrangement can include, for example, a screening plate having mixing material passage apertures. These mixing material passage apertures can then preferably be aligned with the mixing material passage apertures in the evaporator medium, in order to be able to provide here as low as possible a flow resistance to the mixing material flowing through the porous medium.

In order to attain as uniform and efficient heating as possible over the surface of the porous evaporator medium, it is proposed that the heating device has a heating element which runs at least locally curved or spirally. The heating of the porous evaporator medium can furthermore be still more efficiently designed in that the evaporator medium is at least partially arranged in a spatial region surrounded by the heating element.

In an alternative embodiment, it can be provided that an electrically operable mixing material heating device is provided in an upstream region—in relation to the throughflow of the mixing material through the evaporator medium—of the mixing material conducting arrangement and spaced apart from the evaporator medium. In this alternative, the heat supplied by means of an electrically operable heating device is thus not introduced directly into the porous evaporator medium, but is used for heating the mixing material to be conducted through this. The heated mixing material enters the porous evaporator medium and thus heats this and the liquid fuel contained therein.

As already mentioned at the beginning, it is necessary for the performance of an efficient catalytic process that the temperature of the system components in this region is over about 300° C. In order to reach these temperatures as quickly as possible, above all in the starting phase, it is proposed that a mixing/combustion chamber is provided downstream of the evaporator medium with respect to the flow of mixing material through the evaporator medium, and the mixture introduced into the said chamber can be ignited therein by means of an ignition member. By combustion of at least a portion of the mixture in a region situated upstream of the catalyst material, it is arranged that the hot exhaust gases resulting from the combustion flow toward the catalyst material and very quickly heat this or the system region having this. If the temperature in this region is sufficiently high, the combustion can be stopped, for example by changing the hydrocarbon/mixing material ratio, in order to then continue or start the catalytic reaction after setting a suitable mixture ratio.

Furthermore, a heat exchanger arrangement can be associated with the reformer according to the invention, for the transfer of process heat out to the mixing material provided for mixture formation. This process heat, thus for example heat transported by those gaseous materials which leave the catalyst material, or possibly also the process heat produced in a fuel cell, then contributes to a preheating of the mixing material which is passed at least partially through the porous evaporator medium. This means that after starting the process, thus for example after the start of a catalytic reaction, a further operation of an electrical heating element is not required, since sufficient heat energy for evaporating the liquid hydrocarbon contained in the porous evaporator medium is transported by the mixing material preheated in the heat exchanger.

The present invention further relates to a reformer that has an evaporator arrangement according to the invention.

Although an important field of use of an evaporator arrangement according to the invention is in the field of reformers, i.e., systems in which hydrogen is produced from a hydrocarbon/mixing material mixture, for example for electricity generation in a fuel cell, the evaporator arrangement according to the invention can of course also be used in other fields. For example, it can find application in heating devices in which evaporated fuel is combusted together with a further combustion medium, for example, combustion air or another mixing material, and the heat then transported in the combustion exhaust gases is transferred in a heat exchanger to air to be heated or to another medium to be heated. A further field of use is the purification of exhaust gases that are emitted by an internal combustion engine. Thus the evaporator arrangement according to the invention can here be used in an exhaust gas conducting system, for example an exhaust system of a motor vehicle, for the production of an ignitable mixture of hydrocarbon and mixing material, generally air.

### BRIEF DESCRIPTION OF THE DRAWINGS

The invention is described hereinafter with reference to the accompanying drawings and using preferred embodiments.

FIG. 1 shows a longitudinal sectional diagram of the principle of a reformer according to the invention, according to a first embodiment;

FIG. 2 shows a longitudinal sectional diagram of a porous evaporator medium with the heating device associated with it;

FIG. 3 shows a diagram corresponding to FIG. 2 of an alternative embodiment;

FIG. 4 shows a diagram corresponding to FIG. 1 of an alternative embodiment of a reformer.

### DETAILED DESCRIPTION OF THE INVENTION

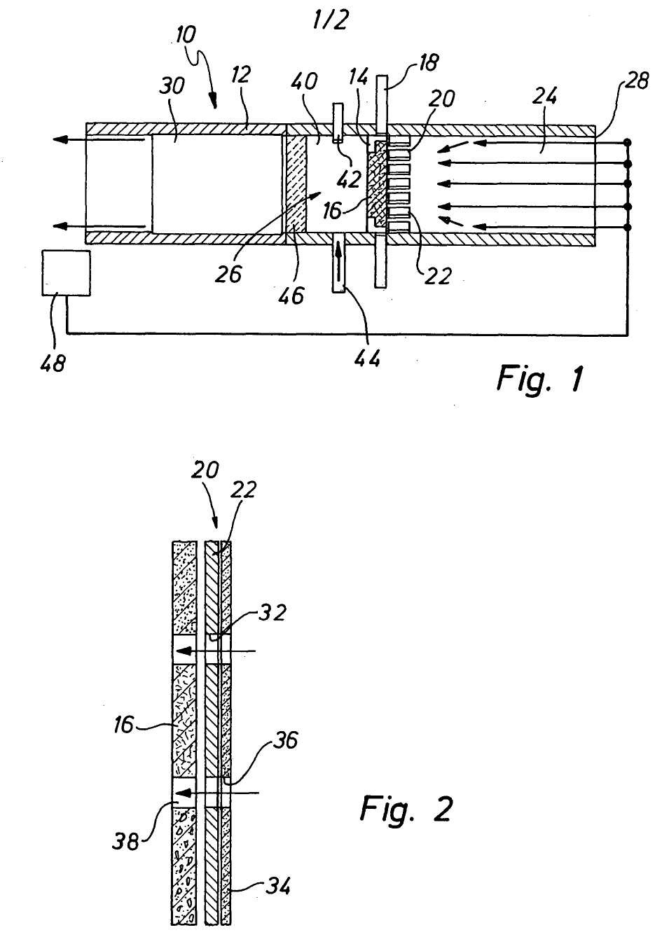

A reformer according to the invention is denoted by 10 in FIG. 1. This reformer 10 comprises a, for example tubular elongate, housing 12. A porous evaporator medium 16, for example formed as a plate or disk, is supported in the housing 12 by means of an annular support 14. This porous evaporator medium can be constructed, for example, from pressed, sintered wire pieces, woven or knitted material, foam ceramic, nonwoven material, grid structures, spun yarn, or the like. A fuel supply duct arrangement 18 leads at plural peripheral regions to the evaporator medium 16 so that liquid fuel, for example diesel fuel, can be fed into the evaporator medium 16 in a manner distributed as uniformly as possible over the periphery. On one side of the evaporator medium 16 and associated therewith is provided an electrically operable heating device 20. This can comprise a heating element 22, for example wound in a spiral or meandering form, which is in direct heat transfer contact with the evaporator medium 16. When the heating device 20 is activated, the evaporator medium 16 is heated, so that the evaporation of the liquid fuel or hydrocarbon contained therein can be increased or brought about.

The internal space of the housing 12 is divided into an upstream region 24 and a downstream region 26 by the evaporator medium 16. The upstream region 24 forms at least a portion of an air conducting arrangement 28, by means of which the air as the mixing material, or a portion thereof, is supplied together with the evaporated fuel or hydrocarbon to a catalyst 30 provided in the downstream region 26 and used for hydrogen recovery. At least a portion of this air thus flows through the upstream region 24 of the housing 12 to the porous evaporator medium 16. This air, which is forwarded, for example, by a fan (not shown), penetrates through the porous evaporator medium 16, and in doing so entrains the evaporated fuel already present in this evaporator medium 16, or increases the evaporation, so that not only an improved evaporation but also improved mixing of the air with the fuel can be attained by this throughflow. Before this air enters the evaporator medium 16, however, it flows past the heating device 20, for example in the interspaces formed between the respective coil or heating element sections. In order to make sure that the heat provided by the heating device 20 is substantially used only for heating the evaporator medium 16 or the fuel contained therein and not for heating the air flowing in the upstream region, the heating device 20, or its heating element 22, is screened from the inflowing air by a screen arrangement. An example of this is schematically shown in FIG. 2. The porous evaporator medium 16 can be seen, and the heating device 20 arranged upstream thereof, with its heating element 22. Apertures 32 are provided in different regions of the heating element 22: for example, the interspaces formed between the spiral or helical sections, or hole-like apertures in the case of a more or less plate-like design of the heating element 22. A screening plate 34 is provided upstream relative to the heating element 22, and is preferably constructed of thermally insulating material, for example, a ceramic material. This plate also has apertures 36 associated with the apertures or passage regions 32 of the heating element 22, so that the air inflowing in the upstream region 24 substantially cannot appear on the heating element 22, but after flowing through the apertures or passage regions 32, 36 strikes the evaporator medium 16. This also preferably has passage apertures 38 for the air, spatially allocated to the apertures 32, 36. The provision of these passage apertures 38 reduces the flow resistance and however likewise has the consequence that the inflowing air passes through the evaporator medium 16 in different regions and entrains fuel or hydrocarbon. In those regions in which the air then exits from the passage apertures 38, vortices are produced so that there also an improved mixing of the evaporated fuel with the air is produced. Air already mixed with fuel then reaches the downstream region, in fact in a mixing/combustion chamber 40. This has an ignition member 42, for example a glow ignition pin, in which the mixture formed as previously described, possibly further mixed with further air supplied through a bypass duct 44, can be brought to ignition and combustion. Further downstream, a flame barrier 46, the function of which is described later, is then located in front of the catalyst 30. Furthermore, the system according to the invention can have a heat exchanger arrangement 48 by means of which the air to be fed into the upstream region 24, or air to be fed generally into the housing 10, can be preheated. This heat exchanger arrangement 48 can recover the heat to be transferred to the air from the process heat which, for example, is produced by the catalytic reaction in the catalyst 30, or which, for example in use in connection with a fuel cell system, is also produced there.

The functioning or operation of the system shown in FIG. 1 is described hereinafter.

In the starting phase, that is a phase in which the different system components are comparatively cold, the heating device 20 is activated in order to evaporate the fuel fed into the evaporator medium 16. The air flowing in via the upstream region 24 will have ambient temperature; a heat transfer in the heat exchange arrangement 48 is not yet possible, since process heat is not yet present. Mixing of the air with the evaporated fuel is then produced in the manner previously described, so that an ignitable mixture is present in the mixing/combustion chamber 40. This is also brought to ignition by excitation of the ignition member 42, so that the resulting combustion exhaust gases flow toward the catalyst 30. These combustion exhaust gases thereby transport a considerable amount of heat, which is transferred to the catalyst material or the catalyst system region and heats these. If a sufficient temperature is present there, that is, a temperature which makes it possible to start or perform the catalytic reaction, the combustion in the chamber 40 is ended, for example in that the fuel supply is briefly interrupted, or the fuel/air ratio is changed so that combustion is ended. The fuel/air ratio suitable for performing the catalytic reaction is then subsequently set, so that the air enriched with evaporated fuel and possibly also water vapor now flows in the downstream region 26 through the flame barrier 46 to the catalyst 30 and is decomposed there for the recovery of hydrogen. The previously mentioned process heat arises here and can be transferred in the heat exchanger arrangement 48 to the air being fed into the evaporator 10, so that this air, already preheated, then reaches the upstream region 24. The heat energy then transported in the air is alone now sufficient to heat the evaporator medium 16 or keep it hot so that the fuel fed into it is caused to evaporate. The heating device 20 then no longer has to be operated. The flame barrier 46 is substantially provided to avoid backflashes or external ignition arising from the catalyst material. These can arise when, with very high temperatures present in the region of the catalyst 30, the risk can arise of ignition of the mixture in the spatial region situated upstream of the catalyst 30. The flame barrier 46 then prevents a propagation of the flames back in the direction of the mixing/combustion chamber 40. Spontaneous ignition of the fuel in the mixing/combustion chamber 40 is also thereby avoided.

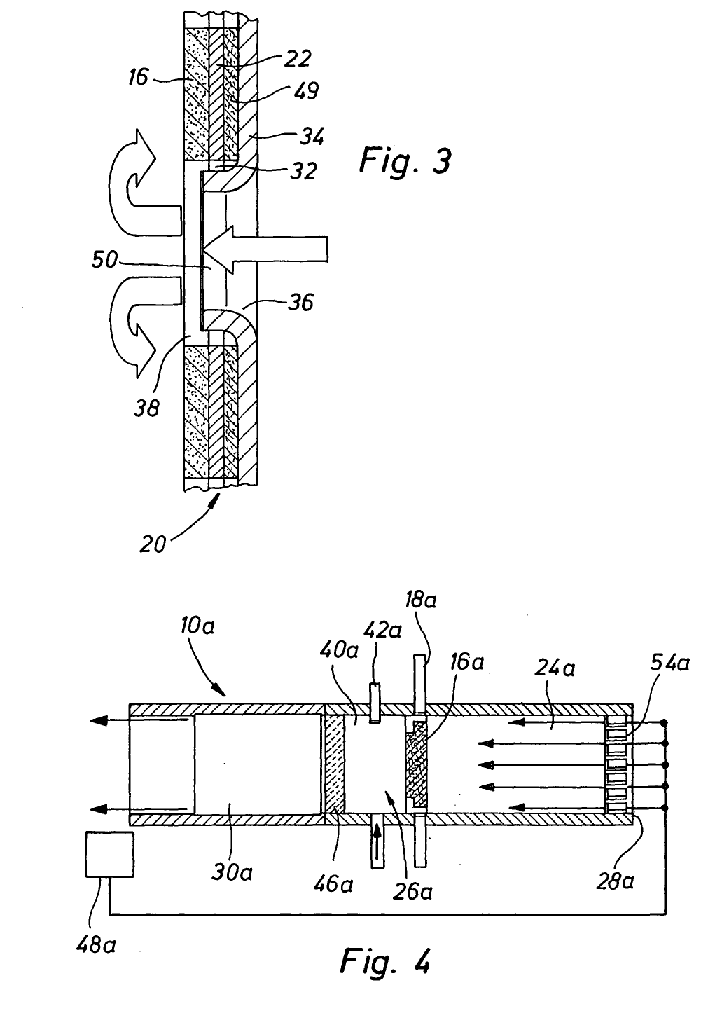

Various changes can be made to the evaporator 10 described hereinabove. Thus it is of course possible to differently form, in particular, the region of the porous evaporator medium or of the heating device. A modification is shown, for example, in FIG. 3. There can furthermore be seen there a screening plate 34, for example made of sheet metal material, and an insulating material 48 between this and the heating element 22 of the heating device 20. Following the heating device 20, and preferably in direct bodily contact with this, the evaporator medium 16 is further arranged. The apertures 36 of the screening plate 34 are here formed in the region of preferably cylindrical shoulders 50 which extend over a short region in the flow direction and bridge over the insulating material 48 and preferably also the heating device 20 and end, for example, in the region of, or in front of, the passage apertures 38 of the evaporator medium 16, so that air flowing in there can then come into contact with the evaporator medium 16 or the fuel or hydrocarbon contained therein.

In a further modification, it can be provided that the evaporator medium 16 penetrates at least locally into the interspaces between the sections of the heating element 22 extending for example spirally or in meandering form, so that an improved heat transfer contact exists between the heating element 22 and the evaporator medium 16. However the evaporator medium 16 preferably nevertheless also has in this case a disk-like region in order to facilitate as uniform a fuel supply as possible. Furthermore, it is also possible for the evaporator medium 16 to be arranged upstream with respect to the heating device 20, and thus for the spatial arrangement of these two components in the case of FIG. 2 to be interchanged. In this case, in which the same conditions prevail as regards heat transfer between the heating device 20 and the evaporator medium 16, the evaporator medium 16 also at the same time forms the heat screening for the heating device 20, so that no additional members have to be provided for this. Should it be necessary to screen the heating device 20 with respect to the combustion/mixing chamber 40, this can for example also take place in that the heating device 20 is embedded in the material of the evaporator medium. In this case, the evaporator medium can for example comprise two disk-like regions, or which at least one can then locally penetrate into the interspaces between different regions or sections of the heating element. In dependence on the positioning of the heating device 20 relative to the evaporator medium 16, the fuel supply into the evaporator medium 16 can take place downstream of, upstream of, or in the region of, the heating device.

An alternative embodiment of an evaporator according to the invention is shown in FIG. 4. Components which correspond in structure or function to previously described components are denoted with the addition of “a”. The following deals only with the differences.

It can be seen here that the heating device associated with the evaporator medium 16a is no longer present. Rather, an air heating device 54a is provided further upstream in the upstream region 24a, and preheats air flowing into the upstream region 24a via the air conducting arrangement 28a. The air then transports heat to the evaporator medium 16, where it is in turn used for evaporating the fuel introduced into this. Also, this electrically operable air heating device 54a is preferably activated only in the starting phase. If then process heat arises in any system region, this heat can in turn be used by the schematically indicated heat exchanger arrangement 48a to preheat the air being fed into the evaporator 10a. The air heating device 54a can then be deactivated. However, it is furthermore provided in this embodiment also that at least a portion of the air to be used for mixture formation flows through the evaporator medium 16a, preferably in the region of passage apertures provided therein, thus making sure of a very good mixing, distributed over the whole cross section of the evaporator medium 16a, of the air, serving for mixture formation and possibly enriched with water or water vapor, with fuel or hydrocarbon.

By the present invention, an evaporator arrangement is provided for producing a hydrocarbon/air mixture, possibly enriched with water vapor, usable in a reformer, by means of which very good mixing of the air with fuel, i.e., a very homogeneous mixture, can be attained over the whole flow cross section. Above all, the provision of passage apertures in the evaporator medium reduces the flow resistance to the air flowing through this, thus contributing to energy saving due to the fact that the heating device acting directly either for air heating or for heating the evaporator medium only has to be operated in the starting phase. Above all the production of a very homogeneous mixture then also leads to a high quality catalysis reaction proceeding in the catalyst with only a small amount of residues. It should also be mentioned that the mixture formation can also take place with the use of water vapor as mixing material.

We claim:

1. Evaporator arrangement, particularly for the production of a hydrocarbon/mixing material mixture which can be decomposed for hydrogen recovery in a reformer, including a porous evaporator medium (16; 16a), a hydrocarbon supply duct arrangement (18, 18a) for supplying hydrocarbon to the porous evaporator medium (16; 16a), and also a mixing material conducting arrangement (28; 28a) for conducting through the evaporator medium (16; 16a) at least a portion of the mixing material provided for mixture formation.

2. Evaporator arrangement according to claim 1, wherein the evaporator medium (16; 16a) has numerous mixing material passage apertures (38).

3. Evaporator arrangement according to claim 1, wherein an electrically operable heating device (20) is associated with the evaporator medium (16).

4. Evaporator arrangement according to claim 3, wherein the heating device (20) is arranged—in relation to the flow of mixing material through the evaporator medium (16)—on an upstream side of the evaporator medium (16) and in heat transfer contact therewith.

5. Evaporator arrangement according to claim 4, wherein the heating device (20) has associated with it a screening arrangement (34) to screen it off from the mixing material flowing to the evaporator medium (16)

6. Evaporator arrangement according to claim 5, wherein the screening arrangement (34) includes a screening plate (34) having mixing material passage apertures (36).

7. Evaporator arrangement according to claim 3, wherein the heating device (20) has a heating element (22) which runs at least locally curved or spirally.

8. Evaporator arrangement according to claim 7, wherein the evaporator medium (16) is at least partially arranged in a spatial region surrounded by the heating element (22).

9. Evaporator arrangement according to claim 1, wherein an electrically operable mixing material heating device (54a) is provided in an upstream region—in relation to the throughflow of the mixing material through the evaporator medium (16)—of the mixing material conducting arrangement (28) and spaced apart from the evaporator medium (16).

10. Evaporator arrangement according to claim 1, wherein a mixing/combustion chamber (40; 40a) is provided downstream of the evaporator medium (16; 16a) with respect to the flow of mixing material through the evaporator medium (16; 16a), and the mixture introduced into the said chamber (40; 40a) can be ignited therein by means of an ignition member.

11. Evaporator arrangement according to claim 1, wherein it has a heat exchanger arrangement (48; 48a) for the transfer of process heat out to the mixing material provided for mixture formation.

12. Reformer for the recovery of hydrogen from a hydrocarbon/mixing material mixture, comprising an evaporator arrangement (10; 10a) according to claim 1.

13. Reformer according to claim 12, wherein the mixing material comprises at least one of air and water vapor.

14. Heating device for heat generation by combustion of a hydrocarbon/mixing material mixture, comprising an evaporator arrangement according to claim 1, for the production of the hydrocarbon/mixing material mixture.

15. Exhaust gas purification system for purifying the gases emitted by an internal combustion engine, including an evaporator arrangement according to claim 1, for the production of a hydrocarbon/mixing material mixture.
